(19) United States
(12) Patent Application Publication
(10) Pub. No.: US 2006/0128343 A1
(43) Pub. Date: Jun. 15, 2006

(54) Method for processing an analog signal and device therefor

(76) Inventors: Valery Leblond, Valence (FR); Nicolas Martin, Bourg-Les-Valence (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/539,621

(22) PCT Filed: Dec. 12, 2003
(86) PCT No.: PCT/EP03/50998

§ 371 Date: Jan. 31, 2006

(30) Foreign Application Priority Data
Dec. 17, 2002 (FR) 02/16000

(51) Int. Cl. H04B 1/06; H04B 1/26

(52) U.S. Cl. 455/313; 455/266

(57) ABSTRACT

The invention relates to a method of processing an analog signal whose frequency spectrum exhibits over a determined bandwidth two main lobes separated by a frequency band where the power is negligible; it comprises a step of sampling according to a determined sampling frequency, and prior to this sampling step, a step consisting in performing a frequency translation of the two main lobes towards one another with a view to reducing the bandwidth and hence the sampling frequency.

The invention relates to a method of processing an analog signal whose frequency spectrum exhibits over a determined bandwidth two main lobes separated by a frequency band where the power is negligible.

A subject of the invention is also a device for processing a corresponding analog signal.

The field of the invention is that of satellite based radionavigation.

Current radionavigation systems such as the GPS, GLONASS systems, are systems for positioning in three dimensions, based on the reception of signals transmitted by a constellation of satellites.

The signal transmitted by a satellite is typically composed of a carrier modulated with a spreading code and possibly data; BPSK modulation (the acronym standing for Binary Phase Shift Keying) which gives a carrier exhibiting phase jumps of π on each change of the binary code, is commonly used in current systems.

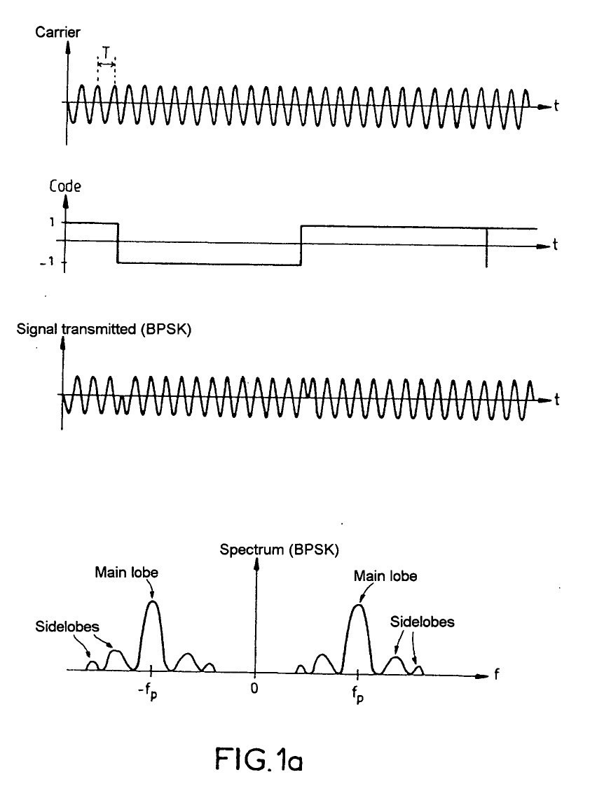

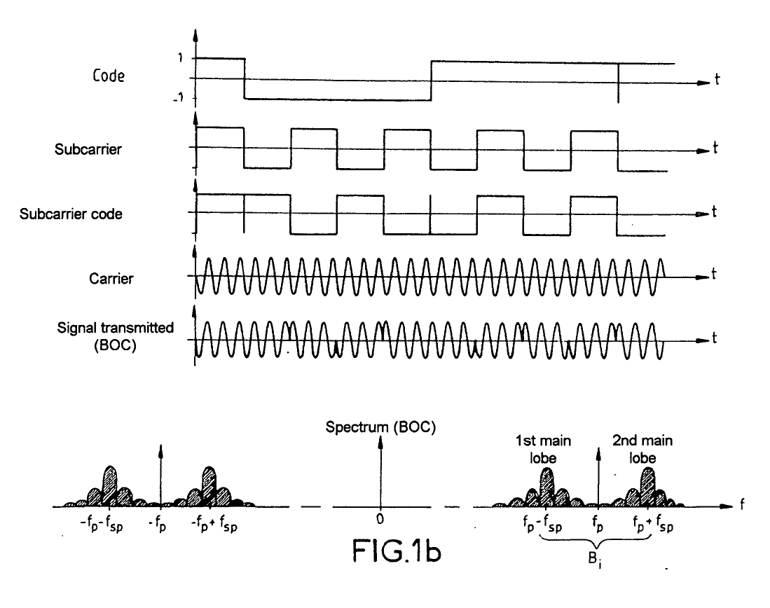

Represented in FIG. 1a is a carrier of period T, a random binary spreading code of frequency F_{code}, the resulting signal, modulated according to a BPSK modulation (designated the BPSK signal for simplicity) and the envelope of the corresponding frequency spectrum. The frequency spectrum of a BPSK signal has (in terms of power) an envelope of the form 1/F_{code}.sin c²(|f−fₚ|/F_{code}) with sin c

$$x = \frac{sin π x}{π x}$$

which exhibits two unique main lobes centered respectively on the carrier frequency fₚ(fₚ=1/T), and the frequency −fₚ of the adjacent sidelobes.

In order to improve the navigation performance such as the accuracy of the positioning, the resistance to jamming, . . . , the new satellite based navigation systems (improved GPS, Galileo, use BOC modulation (the acronym standing for Binary Offset Carrier). Represented in FIG. 1b is the signal resulting from the same carrier and from the same spreading code, but this time modulated according to a BOC modulation (designated BOC signal for simplicity), and the envelope (in terms of power) of the corresponding frequency spectrum, which is of the form
1/F_{code}.sin c²(|f−fₚ|/F_{code}).sin²(π|f−fₚ|/2fₛₚ)/cos²(π|f−fₚ|/2fₛₚ).
The frequency spectrum of a BOC signal exhibits two identical main lobes spaced either side of fₚ (respectively −fₚ), with each of the adjacent sidelobes, as represented in FIG. 1b. The BOC modulation may be regarded as being a BPSK modulation applied after having previously multiplied the carrier by a subcarrier whose frequency fₛₚ is often a multiple of fₚ.

The signal transmitted by the satellite is an analog signal which, after having traversed the distance between the satellite and the receiver, is converted by the receiver into a digital signal with a view to subsequent digital processing. This conversion comprises a step of sampling the spectrum of the signal received by the receiver, followed by a digitizing step. The sampling is carried out according to a sampling frequency fe. It is known that in order to comply with Shannon's criterion which makes it possible to avoid spectral aliasing, the sampling frequency fe must be greater than or equal to the bandwidth of the spectrum.

Now, the spectrum of a BOC signal, whose lobes are spaced apart, has a wider frequency band than that of a BPSK signal, as illustrated in FIGS. 1a) and 1b): as a result, the sampling of a BOC signal is carried out according to a higher sampling frequency than that of a BPSK signal. Now, the use of a high sampling frequency has the drawback of inducing extra cost and an increase in consumption.

A solution for alleviating this drawback consists in processing only part of the spectrum after analog filtering: this makes it possible to reduce the frequency band before sampling. However, it results in a loss of power of the digital signal obtained and a loss of accuracy in the position.

An important aim of the invention is therefore to preserve the advantages related to BOC modulation while reducing the sampling frequency.

To achieve these aims, the invention proposes a method of processing an analog signal whose frequency spectrum exhibits over a determined bandwidth two main lobes separated by a frequency band where the power is negligible, chiefly characterized in that it comprises a step of sampling according to a determined sampling frequency, and prior to this sampling step, a step consisting in performing a frequency translation of the two main lobes towards one another with a view to reducing the bandwidth and hence the sampling frequency.

This translation may be obtained by two procedures.

The step of translating the lobes may be obtained by multiplying the analog signal by a signal of the type cos(ω t), ω being determined as a function of the subcarrier frequency and of the bandwidth of the main lobes; the translation of the main lobes having generated spurious lobes, the method furthermore comprises, prior to the sampling, a step of filtering the translated lobes, with a view to eliminating the spurious lobes.

The translation of the lobes and the sampling may be grouped together into a single step consisting in sampling the analog signal according to a specific sampling frequency feₛ; the analog signal having been modulated by a carrier and a subcarrier of frequency fₛₚ, the frequency feₛ is related to the frequency fₛₚ by the following relation fₛₚ=N.feₛ−feₛ/4, N being a determined integer greater than or equal to 1.

It preferably comprises a prior step of converting the analog signal to baseband.

The analog signal may be a signal modulated according to a BOC type modulation.

According to a characteristic of the invention, the BOC signal comprising a carrier, a code and a subcarrier, respectively exhibiting determined frequencies, the method comprises a step of digitizing the sampled signal and a step of demodulating the digitized signal based on the use of a code and of a subcarrier that are generated locally, the local code being generated on the basis of the frequency of the code, the local subcarrier being generated on the basis of the frequency of the subcarrier determined and reduced during the step of translating the lobes.

The analog signal is a radionavigation signal.

A subject of the invention is also a device for processing an analog signal whose frequency spectrum exhibits over a determined bandwidth two main lobes separated by a frequency band where the power is negligible, characterized in that it comprises an element for translating the frequency of the main lobes towards one another which is able to reduce the bandwidth.

The invention finally relates to a receiver of a radionavigation system comprising such a device.

Other characteristics and advantages of the invention will become apparent on reading the detailed description which follows, offered by way of nonlimiting example and with reference to the appended drawings, in which:

FIG. 1a) diagrammatically represents a carrier of period T, a random binary spreading code equal to 1, −1, 1, 1, . . . , and the resulting BPSK signal transmitted, expressed as a function of time and the envelope of the corresponding frequency spectrum, expressed in terms of power,

FIG. 1b) diagrammatically represents the same code and carrier as those of FIG. 1a) as well as a subcarrier and the product of the code times this subcarrier expressed as a function of time and the envelope of the corresponding frequency spectrum, expressed in terms of power,

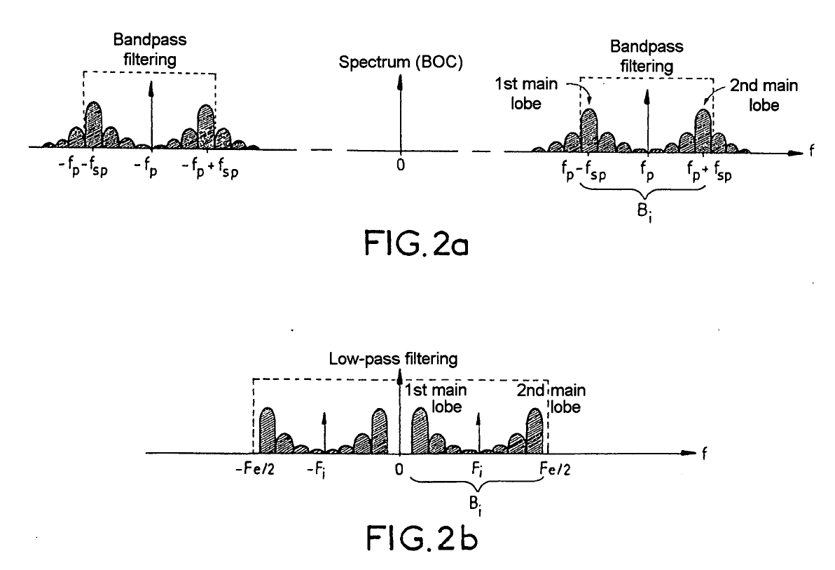

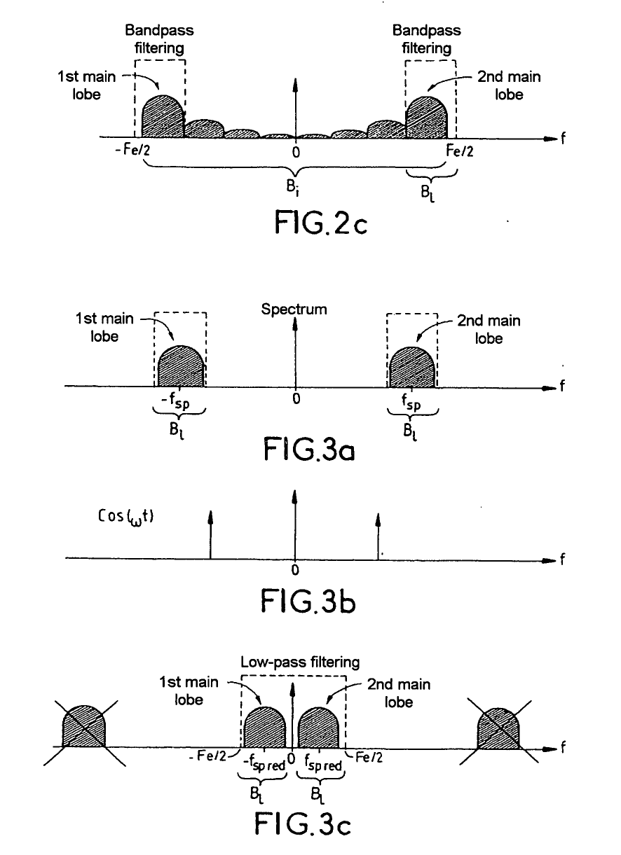

FIGS. 2a), 2b) and 2c) diagrammatically represent the envelopes of the frequency spectra (expressed in terms of power) of the BOC signal of FIG. 1b), at the output of the antenna of the receiver (FIG. 2a), after its conversion to intermediate frequency Fi (FIG. 2b) and baseband (FIG. 2c),

FIGS. 3a), 3b) and 3c) diagrammatically represent (expressed in terms of power) the envelope of the frequency spectrum of the BOC signal of FIG. 2c) after filtering (FIG. 3a), the frequency spectrum of a cos(ωt) signal (FIG. 2b) and the envelope of the frequency spectrum of the BOC signal of FIG. 3a whose lobes have undergone a translation by an analog procedure (FIG. 3c),

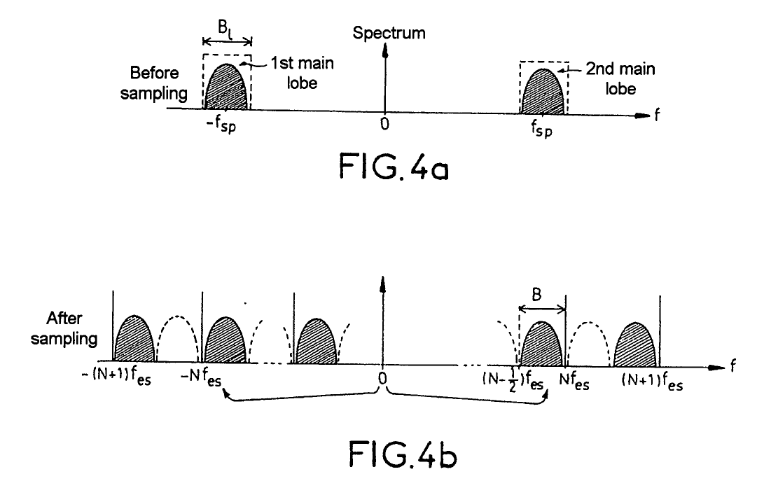

FIGS. 4a) and 4b) diagrammatically represent (expressed in terms of power) the envelope of the frequency spectrum of the BOC signal of FIG. 2c) after filtering (FIG. 4a) and the envelope of the frequency spectrum of the BOC signal of FIG. 4a whose lobes have undergone a translation by a digital procedure (FIG. 4b),

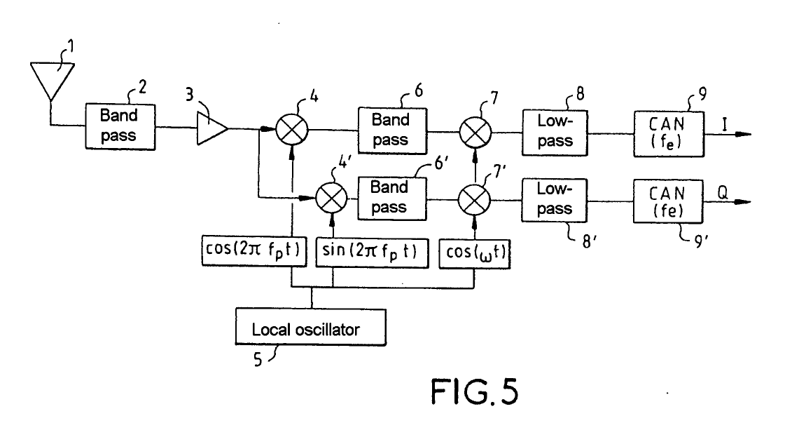

FIG. 5 diagrammatically represents a first embodiment of a device for processing an analog signal according to the invention,

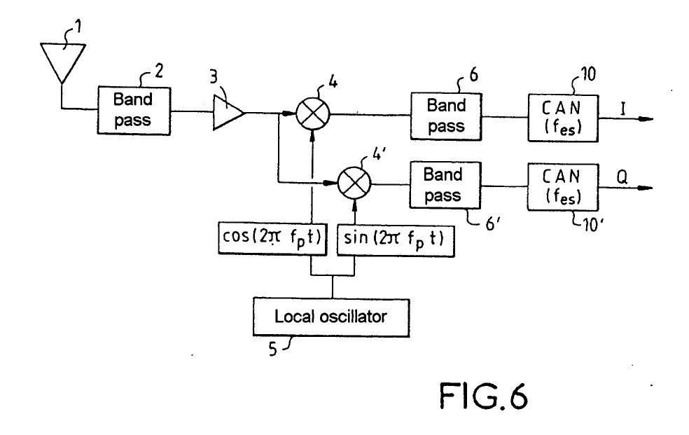

FIG. 6 diagrammatically represents a second embodiment of a device for processing an analog signal according to the invention,

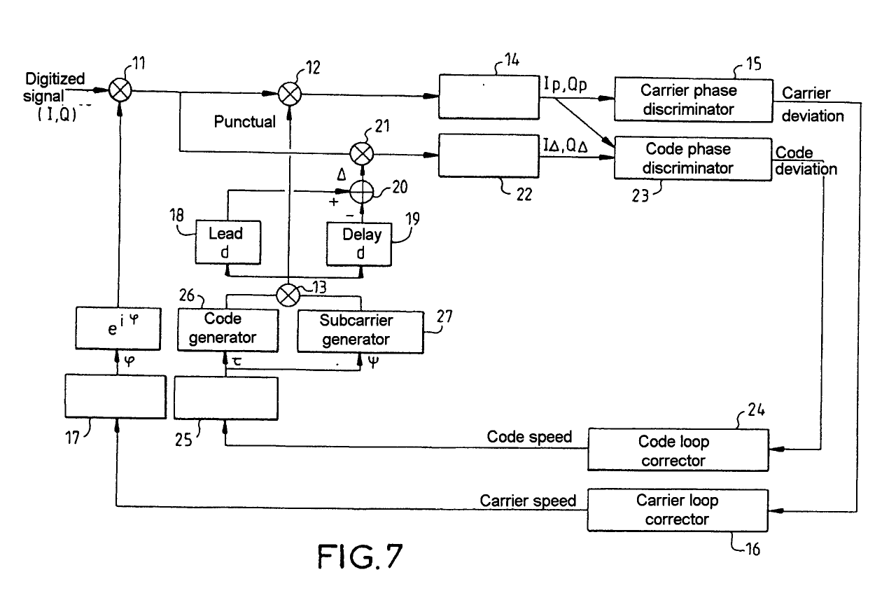

FIG. 7 diagrammatically represents the feedback loop for slaving the carrier and slaving the code and the subcarrier in the case of a device for processing a conventional BOC signal,

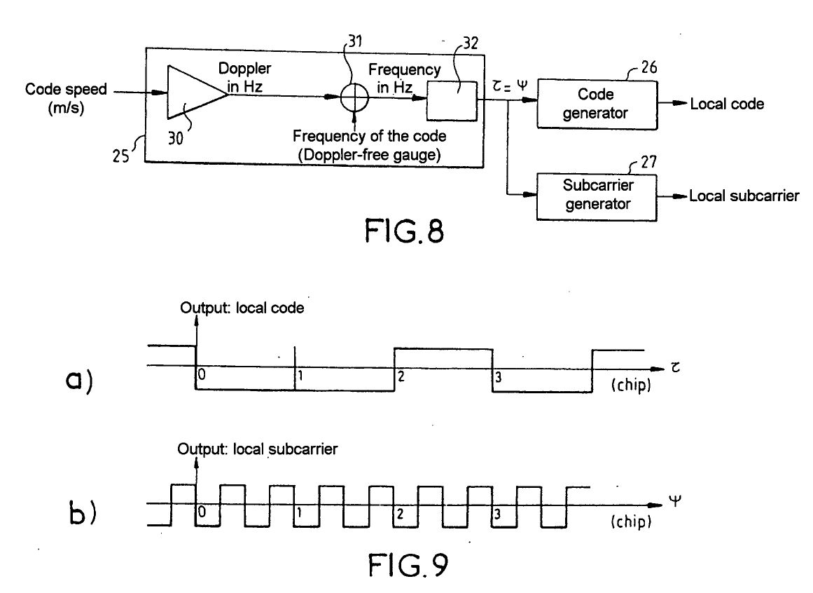

FIG. 8 diagrammatically represents an element for calculating the local phase common to the code generator and the subcarrier generator in the case of a device for processing a conventional BOC signal,

FIGS. 9a) and 9b) diagrammatically represent the local code (FIG. 9a) and the local subcarrier (FIG. 9b) as a function of the local phases expressed in terms of chips, in the case of a device for processing a conventional BOC signal,

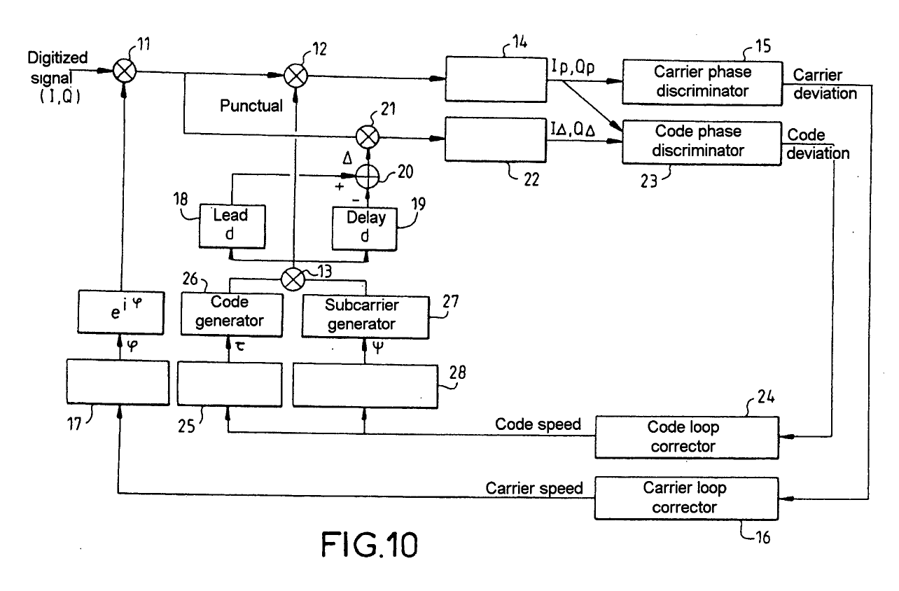

FIG. 10 diagrammatically represents the feedback loop for slaving the carrier and for slaving the code and the subcarrier in the case of a device for processing a BOC signal according to the invention,

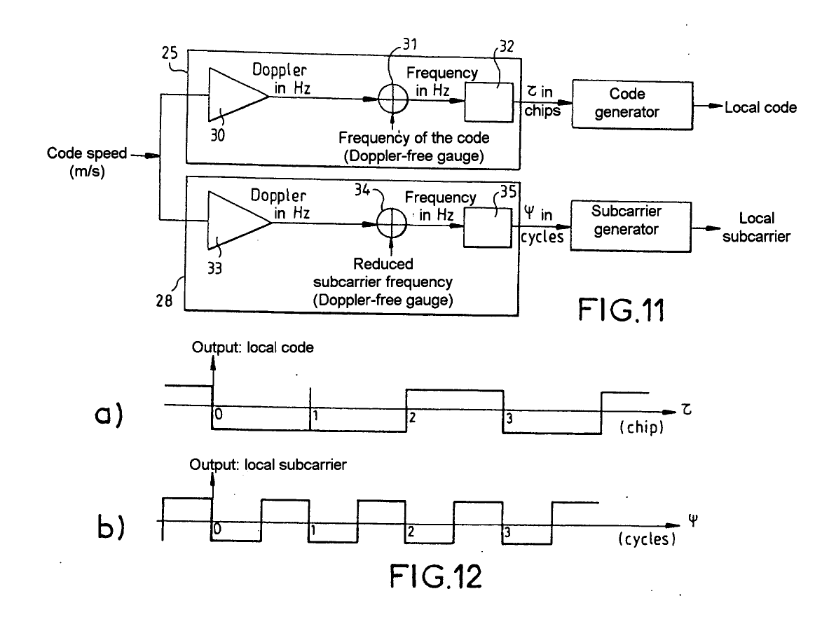

FIG. 11 diagrammatically represents an element for calculating the phase of the local code and an element for calculating the phase of the local subcarrier in the case of a device for processing a BOC signal according to the invention,

FIGS. 12a) and 12b) diagrammatically represent the local code (FIG. 12a) as a function of the local phase expressed in terms of chips and the local subcarrier (FIG. 12b) as a function of the local phase expressed in cycles, in the case of a device for processing a BOC signal according to the invention.

A BOC signal will now be more particularly considered. The method according to the invention aims to reduce the sampling frequency of a BOC signal.

At the output of the antenna of the receiver, the BOC signal is, in a conventional manner, converted into baseband, possibly passing through a prior conversion to intermediate frequency Fi. A bandpass filtering is generally applied before the conversion (or conversions) so as to eliminate certain sidelobes; a low-pass filtering is generally applied after the conversion(s).

Represented is the spectrum of the BOC signal of FIG. 1b at the output of the antenna of the receiver (FIG. 2a), after its conversion to intermediate frequency Fi (FIG. 2b) then to baseband (FIG. 2c). The bandwidth of the spectrum is then Bᵢₙᵢₜᵢₐₗ or Bi. The BOC signal after its conversion to intermediate frequency Fi is a real signal whereas after its conversion to baseband, the signal which comprises a channel I and a channel Q (in quadrature with respect to the I channel), is complex.

Thereafter, the sidelobes of the frequency band situated between the two main lobes are preferably eliminated by filtering so as to avoid aliasing during sampling. The width of the band containing at least one main lobe is designated Blobe, or Bl.

We saw that in order to comply with Shannon's criterion, the sampling frequency fe is greater than or equal to the bandwidth of the spectrum of the BOC signal, in this instance Bi.

It is therefore possible to reduce Fe by reducing the bandwidth, prior to sampling. To do this, the bandwidth of the spectrum of the BOC signal is reduced by performing a frequency translation of the two main lobes towards one another. This translation may be obtained by two procedures.

A first, analog procedure consists in multiplying the I and Q channels by a signal in cos(ωt) represented in FIG. 3b, ω being of the form 2π(fₛₚ−f_{spred}). The spectra before and after multiplication are respectively represented in FIGS. 3a and 3c; after multiplication, each lobe is then centered on a reduced subcarrier frequency, f_{spred}. We have f_{spred}≧Bl/2. A last filtering makes it possible to eliminate the spurious lobes so as to avoid aliasing during sampling.

One then obtains a spectrum consisting of two main lobes having undergone a translation towards one another and whose bandwidth is equal to around 2Bl as illustrated in FIG. 3c; the spectrum is then sampled according to a sampling frequency fe greater than or equal to 2Bl.

Another, digital, procedure makes it possible at one and the same time to perform a translation of the main lobes towards one another and to sample: this is obtained by performing a sampling according to a specific sampling frequency feₛ. This frequency feₛ is determined on the basis of the following conditions, aimed at avoiding any overlap between lobes during this specific sampling.
(1) feₛ must be greater than or equal to 2Bl,
(2) fₛₚ+B/2<N.feₛ, N being an integer greater than or equal to 1
(3) (N−½)feₛ<fₛₚ−B/2

These conditions are illustrated in FIGS. 4a and 4b, in which are respectively represented the spectrum before sampling and the spectrum after sampling as desired, that is to say without overlapping of lobes. More particularly represented in FIG. 4b are the first and second main lobes corresponding to the spectral line situated at the frequency 0: to comply with the nonoverlap condition, the frequency band of this first lobe must be situated short of the frequency N.feₛ and beyond the frequency (N−½)feₛ, this giving rise to conditions (1), (2) and (3).

These conditions are fulfilled for fₛₚ=N.feₛ−feₛ/4.

We preferably take for N the largest value fulfilling this condition so as to minimize feₛ.

This digital procedure has the advantage of carrying out two steps (bringing the lobes closer together and sampling) in one and furthermore makes it possible to avoid the need to perform by an analog procedure the double multiplication by the signal cos(ωt).

A translation of the main lobes towards one another by a translation of each lobe was presented in the above examples. A translation of just one lobe towards the other also makes it possible to reduce the bandwidth and may therefore be performed according to a variant of the invention.

The method according to the invention may also be applied to “pseudo-BOC” analog signals obtained on the basis of two signals transmitted by one and the same source and synchronously, on two distinct and close frequencies, each signal being processed as a lobe of the spectrum of a BOC signal. This is for example the case for the Galileo system with signals transmitted in the frequency bands E1 and E2.

In the examples presented, the main lobes are identical, but the invention applies equally in the case where the main lobes are not.

Once sampled according to one of the procedures described previously, the analog signal is digitized. The analog signal thus converted into a digital signal is then processed as a function of the desired application.

An exemplary device for processing an analog signal included in a receiver of a positioning system, represented in FIGS. 5 and 6, will now be described.

At the output of the antenna 1, the analog signal whose carrier exhibits a frequency fp, is filtered by means of a bandpass filter 2 which may be a ceramic filter. The signal is then preferably amplified by a low noise amplifier 3. At this juncture we obtain a signal whose spectrum corresponds to that of FIG. 2a, that is to say ridded of certain sidelobes.

The conversion of this amplified signal to baseband is obtained by multiplying it by means of a multiplier 4 on a first channel designated the I channel by a signal of the form cos(2π.fp.t) and by means of another multiplier 4′ on a second channel designated the Q channel by a signal of the form sin (2π.fp.t). The signals of the form cos (2π.fp.t) and sin(2π.fp.t) emanate from a local oscillator 5. The spectrum of the complex signal (I and Q channel) thus obtained is of the form of that of FIG. 2c.

On each channel, the signal thus multiplied is filtered by means of a bandpass filter 6 or 6′ which may be an RC filter (comprising a resistor R and a capacitor C) or a surface wave filter (SAW filter) so as to eliminate the sidelobes of the frequency band situated between the two main lobes. The signal obtained then has a spectrum as represented in FIG. 3a or 4a.

The implementation of the analog procedure is obtained by disposing as represented in FIG. 5, on each I and Q channel a multiplier 7 or 7′ able to multiply the signal by a signal of the form cos(ω.t) emanating from the local oscillator 5, then a low-pass filter 8 or 8′ making it possible to eliminate the spurious lobes, as indicated in FIG. 3c.

The signal obtained is then sampled by means of a sampler using a sampling frequency fe greater than or equal to 2Bl and digitized by means of a digitizer which produces a digital signal, these sampler and digitizer being grouped together in a converter 9 or 9′.

The implementation of the digital procedure is obtained by disposing directly as represented in FIG. 6 on each I and Q channel a sampler using a sampling frequency feₛ and a digitizer which produces a digital signal, this sampler and digitizer being grouped together in a converter 10 or 10′.

The digital processing of the signal obtained in each of the I and Q channels has then been performed according to the application desired.

The main steps of processing the digital signal in the case of a receiver positioning application based on signals of BOC type transmitted by satellites will now be described. It is recalled as indicated in the preamble that a BOC signal may be regarded as consisting mainly of a carrier, a subcarrier and a code.

In the case of a positioning application based on a conventional BOC signal, it is known to the person skilled in the art that the aim of the processing of the signal is to demodulate the digitized BOC signal into a carrier, subcarrier and code so as to recover the measure of the propagation delay on the basis of the difference between the time of transmission of the code by the satellite and the time of reception of the code by the receiver.

The demodulation is achieved by correlation of the digitized BOC signal with locally generated carrier, subcarrier and code.

These local signals must be generated synchronously with the BOC signal received, taking account in particular of the apriori unknown Doppler effect.

To do this, carrier and code tracking loops are installed, the code loop including the tracking of the subcarrier; these loops slave the phases of the local carrier, subcarrier and code with respect to the phases of the carrier, subcarrier and code of the BOC signal received, on the basis of the measurements emanating from the correlations.

The measurement of the delay in the code and the initial Doppler effect is achieved in an acquisition phase also referred to as a lockon phase which consists in testing in open loop several hypotheses regarding the position of the code and the Doppler effect until the result of the correlation indicates through a high energy level that the phase shift between the signal received and the local signal is a minimum. Thereafter, the search is refined and then the loops are closed.

These demodulation steps are obtained by means of a demodulator comprising feedback loops, an example of which is represented in FIG. 7. In FIGS. 7 and 10, the digitized signal at the input of the feedback loops is as was seen previously a complex signal comprising an I channel and a Q channel.

The correlation of the signal received with the local signal is achieved firstly by multiplying by means of a multiplier 11 the digitized signal by a signal of the form e^{-iφ}, φ being the phase of the local carrier. The signal obtained is then multiplied by means of a multiplier 12 on a so-called punctual channel (hence the notation Iₚ and Qₚ for punctual I channel and punctual Q channel) by a signal representative of the code and subcarrier modulation, and by summing the results obtained at various instants of these multiplications by means of an integration-summation element 14. The signal representative of the code and subcarrier modulation has been obtained by multiplying by means of a multiplier 13, a signal representative of the code generated locally on the basis of τ, by a signal representative of the subcarrier generated locally on the basis of ψ, τ and ψ respectively being the phase of the local code and of the local subcarrier, which are in fact identical in this case.

The result of this correlation is submitted to a carrier phase discriminator 15 which deduces therefrom a carrier deviation which is a real signal and which is injected into a carrier loop corrector 16. A phase calculation element 17 which may be a numerically controlled oscillator calculates the phase φ of the local carrier as a function of the carrier speed emanating from the carrier loop corrector 16, and of the frequency of the carrier without Doppler effect, referred to as the carrier gauge frequency. The carrier speed is the speed of propagation of the carrier measured on reception: from this one deduces the variation in frequency of the carrier due to the Doppler effect. This phase φ thus slaved is used by a carrier generator to generate a local carrier of the form e^{-iφ.}

The correlation of the signal received with the local signal is achieved likewise on a so-called delta channel (hence the notation I_{Δ} and Q_{Δ} for delta I channel and delta Q channel), by multiplying by means of a multiplier 21 the digitized signal multiplied by a signal of the form e^{-iφ}, by a so-called delta signal. This delta signal emanating from a summator 20 is the difference of the signal representative of the code and carrier modulation which has undergone a lead by means of a device 18 making it possible to advance the signal with respect to that of the punctual channel and a delay by means of a device 19 making it possible to delay the signal with respect to that of the punctual channel. The results obtained at various instants of these multiplications are summed by means of an integration-summation element 22.

The result of this correlation and the result of the punctual channel is submitted to a code phase discriminator 23 which deduces therefrom a code deviation which is a real signal and which is injected into a code loop corrector 24. A phase calculation element 25 which may be a numerically controlled oscillator calculates the phases τ and ψ of the local code and of the local subcarrier as a function of the code speed (identical to the subcarrier speed) emanating from the code loop corrector 24 and the code gauge frequency. The code speed is the speed of propagation of the code measured on reception: from this we deduce the variation in code frequency due to the Doppler effect. The phases τ and φ of the code and of the subcarrier which are identical, are thus slaved and then respectively used by a code generator 26 to generate the local code and by a subcarrier generator 27 to generate the local subcarrier.

As these phases are identical they are calculated by the same phase calculation element 25. Represented in FIG. 8 is the detail of a code phase calculation element 25. It comprises a converter 30 of the code speed expressed in m/s, into a measurement expressed in Hz of the frequency variation due to the Doppler effect, the conversion being performed on the basis of the chip of the code; the phase calculation element furthermore comprises a summator 31 of this measurement of the Doppler effect and of the code gauge frequency and an integrator 32 transforming this new frequency into a phase τ. Represented in FIG. 9a) is the local code generated by the code generator 26 as a function of the local phase expressed in chips, the chip being the wavelength of the code; FIG. 9b) represents the local subcarrier generated by the subcarrier generator 27 as a function of the local phase also expressed in chips, since the same phase calculation element 25 has been used for both generators 26 and 27.

In the case of the invention, the sampling frequency used at the level of the receiver has been reduced by means of a translation towards one another of the main lobes of the spectrum of the signal received. This translation has reduced the frequency of the subcarrier which has become f_{spred}. The reduced subcarrier frequency then being different (lower) from the frequency of the code, it is therefore necessary to divorce the element for calculating the phase of the subcarrier which takes account of the reduced subcarrier frequency, from the element for calculating the phase of the code which takes account of the frequency of the code as represented in FIG. 10.

Represented in FIG. 11 are the details of the phase calculation elements 25 and 28 respectively used for the code and for the subcarrier. The phase calculation element 25 used for the code is the same as that of FIG. 8. The phase calculation element 28 used for the subcarrier comprises a converter 33 of the code speed (which is the same as the subcarrier speed) expressed in m/s, into a measurement expressed in Hz of the frequency variation due to the Doppler effect, the conversion being performed on the basis of the wavelength of the subcarrier expressed in cycles; the phase calculation element furthermore comprises a summator 34 of this measurement of the Doppler effect and of the reduced gauge frequency of the subcarrier and an integrator 35 transforming this new frequency into a phase ψ. It will be noted that the Doppler effect is independent of the reduction of the subcarrier frequency which intervenes only at the receiver level.

Represented in FIG. 12a) is the local code generated by the code generator 26 as a function of the local phase expressed in chips; FIG. 12b) represents the local subcarrier generated by the subcarrier generator 27 as a function of the local phase expressed in cycles, since a phase calculation element 28 specific to the subcarrier has been used upstream of the generator 27.

When f_{spred}=Bl/2, we have a chip=a cycle as represented in FIG. 12 but this is no longer the case if f_{spred}>Bl/2.

1. A method of processing an analog signal whose frequency spectrum exhibits over a determined bandwidth two main lobes separated by a frequency band where the power is negligible, comprising:
sampling according to a determined sampling frequency, and
prior to the sampling, in performing a frequency translation of the two main lobes towards one another with a view to reducing the bandwidth and hence the sampling frequency.

2. The method as claimed in claim 1, wherein the signal comprising a carrier and a subcarrier of determined frequency and the main lobes exhibiting determined bandwidths, the performing a frequency translation is performed by multiplying the analog signal by a signal of the type cos(ω t), ω being determined as a function of the subcarrier frequency and of the bandwidth of the main lobes.

3. The method as claimed in the claim 2, wherein the translation of the main lobes having generated spurious lobes, and the method furthermore comprises, prior to the sampling, filtering the translated lobes with a view to eliminating the spurious lobes.

4. The method as claimed in claim 1, wherein the translation of the lobes and the sampling are grouped together into a single step consisting in sampling the analog signal according to a specific sampling frequency feₛ.

5. The method as claimed in claim 4, wherein the analog signal having been modulated by a carrier and a subcarrier of frequency fₛₚ, the frequency feₛ is related to the frequency fₛₚ by the following relation fₛₚ=N.feₛ−feₛ/4, N being a determined integer greater than or equal to 1.

6. The method as claimed in claim 5, wherein N is the largest value possible to obtain the relation.

7. The method as claimed in claim 1, further comprising: converting the analog signal to baseband.

8. The method as claimed in claim 7, wherein the frequency spectrum exhibiting sidelobes around each main lobe, the sidelobes eliminated by filtering.

9. The method as claimed in claim 1, characterized in that the main lobes are identical.

10. The method as claimed in claim 1, wherein the analog signal is a signal modulated according to a BOC type modulation.

11. The method as claimed in claim 1, wherein the analog signal is a radionavigation signal.

12. The method as claimed in claim 10, wherein the BOC signal comprising a carrier, a code and a subcarrier, respectively exhibiting determined frequencies, and the method further comprising: of digitizing the sampled signal, and; demodulating the digitized signal based on the use of a code and of a subcarrier that are generated locally, the local code being generated on the basis of the frequency of the code, the local subcarrier being generated on the basis of the frequency of the subcarrier determined and reduced during the step of translating the lobes.

13. The method as claimed in claim 11, wherein the radionavigation signal is that of the Galileo or Glonass or GPS system.

14. A device for processing an analog signal whose frequency spectrum exhibits over a determined bandwidth two main lobes separated by a frequency band where the power is negligible, comprising:
an element for translating the frequency of the main lobes towards one another which is able to reduce the bandwidth.

15. The device as claimed in claim 14 furthermore comprising:
a converter of the analog signal into baseband linked to the device for translating the main lobes and placed upstream of the translation device.

16. The device as claimed in claim 15 furthermore comprising:
a bandpass filter linked to the baseband analog signal converter and placed between the baseband converter and the translation device.

17. The device as claimed in claim 14, wherein the signal comprising a carrier and a subcarrier of determined frequency and the main lobes exhibiting determined bandwidths, the device for translating the main lobes comprises a multiplier of the analog signal by a signal of the type cos(ω t), ω being determined as a function of the subcarrier frequency and of the bandwidth of the main lobes.

18. The device as claimed in claim 17, wherein the device for translating the main lobes furthermore comprises, linked to the multiplier and placed downstream of the latter, a low-pass filter.

19. The device as claimed in claim 17, wherein the multiplier is linked to a sampler.

20. The device as claimed in claim 14, wherein the device for translating the main lobes comprises a sampler able to sample the analog signal according to a specific sampling frequency feₛ.

21. The device as claimed in claim 19, wherein the sampler is linked to a digitizer.

22. The device as claimed in claim 14, wherein the analog signal is a radionavigation signal.

23. The device as claimed in claim 21, wherein the radionavigation signal comprising a carrier, a code and a subcarrier that are generated by a satellite, respectively exhibiting determined frequencies, the device further comprises, linked to the digitizer, a feedback loop for slaving a code and a subcarrier that are generated locally by the device, this loop comprising an element for calculating the local phase of the code on the basis of the code frequency determined and an element for calculating the local phase of the subcarrier on the basis of a subcarrier frequency calculated on the basis of the determined subcarrier frequency, these elements for calculating phase being distinct.

24. The device as claimed in claim 14, wherein the lobes are identical.

25. A receiver of a radionavigation system, comprising:
a device for processing an analog signal according to claim 14.
